(19) United States
(12) Patent Application Publication
(10) Pub. No.: US 2008/0087792 A1
(43) Pub. Date: Apr. 17, 2008

(54) Engine start run stand

(76) Inventor: John W. Evitt SR., New Albany, IN (US)

Correspondence Address: JAMES RAY & ASSOCIATES, 2640 PITCAIRN ROAD, MONROEVILLE, PA, 15146, US

(21) Appl. No.: 11/906,399

(22) Filed: Oct. 2, 2007

Related U.S. Application Data
(60) Provisional application No. 60/849,119, filed on Oct. 3, 2006.

(51) Int. Cl. F16M 3/00

(52) U.S. Cl. 248/676

(57) ABSTRACT

An adjustable apparatus for mounting a carbureted “V” type automotive engine thereon while such engine is either being worked on or being used for teaching purposes. Such apparatus comprises a substantially rectangular base member having side rails and end rails. Upright members are engageable with the base member adjacent each corner. At least two cross members are engageable with the upright members for providing support. Nuts and bolts are used for securing the various components to each other. A first engine support engageable with the side rails is used for holding the body of the engine. Engine support brackets are engageable with at least two upright members and are used for supporting a rear portion of such engine. Wheels are disposed at each corner for providing mobility to the unit.

### CROSS REFERENCE TO RELATED APPLICATIONS

This application is closely related to and claims benefit from U.S. Provisional Application Ser. No. 60/849,119 filed Oct. 03, 2006.

### FIELD OF THE INVENTION

The present invention relates, in general, to an apparatus for working on an automobile engine, and, more particularly, the present invention relates to an adjustable apparatus for building or rebuilding a carbureted “V” type automobile engine.

### BACKGROUND OF THE INVENTION

Working on an engine can be a difficult task. This is particularly true if the mechanic is without the necessary tools. With the engine still mounted in the vehicle, building and rebuilding an engine can be almost impossible and many users lack the tools needed to securely mount an engine for further study. Without a proper engine mount such an operation becomes a true challenge.

Also, a engine mount is also important for a teacher in order to have an engine in the open so that the teacher when teaching or demonstrating can easily show each component of the engine.

Thus, it would be advantageous if there were a engine stand available on which an entire engine block could be mounted allowing the mechanic to fine tune, try new products or install items before doing so in the vehicle or in which a teacher could demonstrate the components and operation of the engine.

### SUMMARY OF THE INVENTION

In a first aspect the present invention provides an apparatus for mounting an automotive engine thereon while such engine is either being worked on or being used for teaching purposes. The apparatus comprises a base member having each of a predetermined shape and a predetermined size. The base member includes at least a pair of side rails and a pair of end rails wherein each of the pair of side rails is engageable with a respective end of each of the end rails so as to form a substantially rectangular base, the base member having each of a front end and a back end. A plurality of upright members are engageable with the base member adjacent each corner of the substantially rectangular base member. There are at least two cross members, each one of the at least two cross members are engageable with a pair of the plurality of upright members for providing support. There is a connection means for securing the side rails to the end rails and to the plurality of upright members to the base member. A first engine support means is engageable with the side rails of the base member while a second engine support means is engageable with at least two of the plurality of upright members. A plurality of wheels engageble with a bottom portion of each of the plurality of upright members disposed substantially at each of the corners of the substantially rectangular base to provide mobility for the apparatus.

### OBJECTS OF THE INVENTION

It is, therefore, one of the primary objects of the present invention to provide a engine start run stand that can be used to build or rebuild an automobile engine.

Another object of the present invention is to provide an engine stand that can be used for carbureted “V” type engines.

Still another object of the present invention is to provide a engine stand for working on engines so as to eliminate the problem of scraping, denting or scratching the body of an automobile while working on the engine.

Yet another object of the present invention is to provide a engine stand that can be used in teaching others about an engine.

Still another object of the present invention is to provide a engine stand that is relatively inexpensive to build.

Another object of the present invention is to provide a engine stand that is adjustable.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a perspective view of the apparatus of the present invention according to an embodiment of the invention.

FIG. 2 is a side perspective view of he apparatus shown in FIG. 1.

FIG. 3 is a perspective view of the apparatus shown in FIG. 1 showing the bracket for storage of the engine's battery and gasoline.

FIG. 4 is a perspective view of the apparatus shown in FIG. 1 showing an engine mounted on the apparatus for either working on the engine or for teaching purposes.

FIG. 5 is a breakdown of the parts used for assembling the apparatus shown in FIG. 1.

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

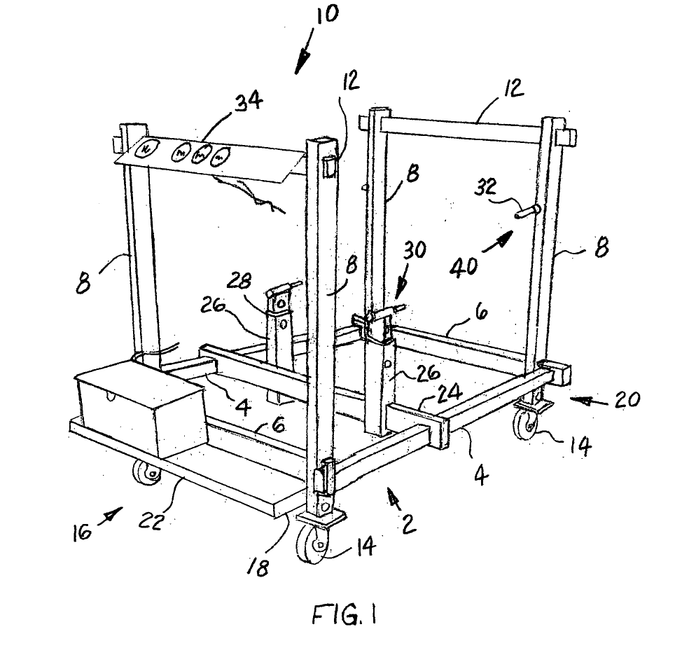

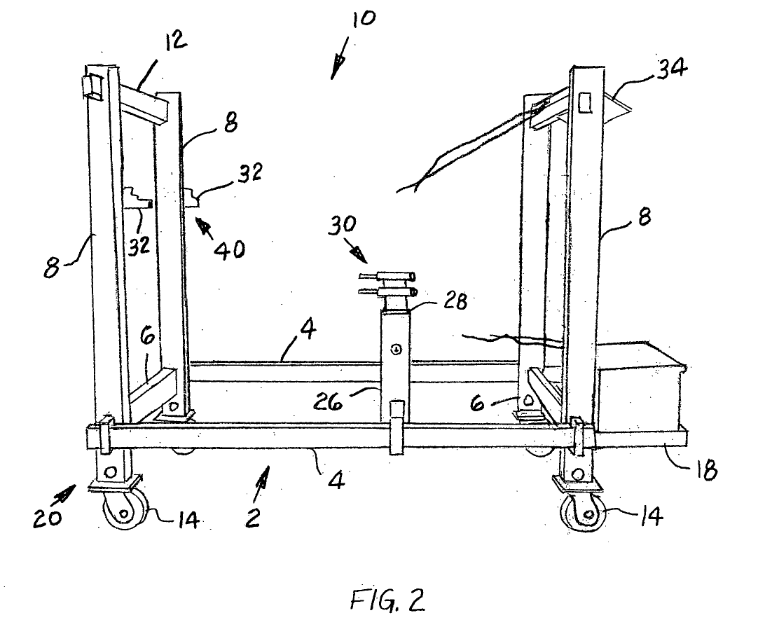

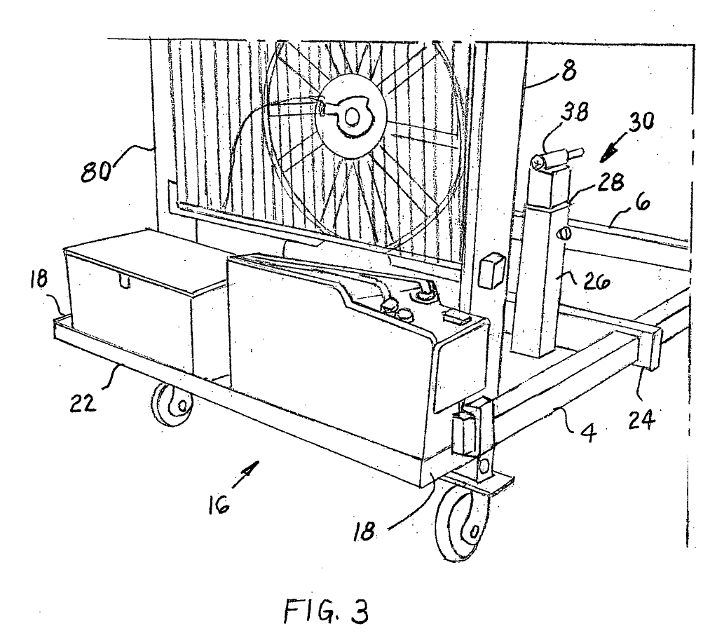

In a first aspect, as seen in FIGS. 1 and 2, the present invention of a engine start run stand provides an adjustable apparatus, generally designated 10, for mounting an automotive engine thereon while such engine is either being worked on or being used for teaching purposes. Apparatus 10 is fully adjustable, since such apparatus 10 does not have any welds but basically uses nuts and bolts and screws for securing parts together. This apparatus 10 is designed primarily for use with carbureted “V” type engines. The apparatus 10 comprises a base member 2 having each of a predetermined shape and a predetermined size. The base member 2 includes at least a pair of side rails 4 and a pair of end rails 6 wherein each of the pair of side rails 4 is engageable with a respective end of each of the end rails 6 so as to form a substantially rectangular base, such base member having each of a front end and a back end. A plurality of upright members 8 are engageable with the base member 2 adjacent each corner of the substantially rectangular base member 2. There are at least two cross members 12, each one of the at least two cross members 12 are engageable with a pair of the plurality of upright members 8 for providing support. There is a connection means, generally designated 20, for securing the side rails 4 to the end rails 6 and to the plurality of upright members 8 to the base member 2. A first engine support means, generally designated 30, is engageable with the side rails 4 of the base member 2 while a second engine support means, generally designated 40, is engageable with at least two of the plurality of upright members 8. A plurality of wheels 14 engageble with a bottom portion of each of the plurality of upright members 8 are disposed substantially at each of the corners of the substantially rectangular base member 2 to provide mobility for the apparatus 10. The wheel 14 mounts are secured to the upright members 8 by means of nuts and bolts.

The base member 2 further includes an additional portion 16 extending beyond the base member 2 for providing additional mounting area for a battery and for a fuel container. Such additional portion 16 has two side members 18 and two end members 22. One of the end members 22 is engageable with such end rail 6 of the base member 2 and upright members 8. The end members 22 are also engageable on each end thereof with a respective end of the side rails 18.

Such first engine support means 30 includes a cross piece 24 that is engageable with each of the side rails 4 of base member 10. The first engine support means 30 also includes a pair of upright support members 26 engageable with the cross piece 24 at a first end thereof. Such pair of upright support members have a height adjustment means 28 disposed therein for providing different heights for different engines to be mounted thereon.

The first engine support means 30 also includes a securement means 50 for securing such engine to the second end of the pair of upright support members 26. Such securement means 50 includes nuts and bolts.

The second engine support means 40 includes a pair of brackets 32, each bracket 32 engageable with a respective one of a first pair of upright members 8 for supporting a rear portion of such engine. Such pair of brackets 32 are adjustable. The first pair of upright members 8 are disposed on a same end of the substantially rectangular base member 2. Such second engine support means 40 is engageable with the pair of upright members 8 by means of nuts and bolts.

It should be noted that such cross piece 24 has apertures adjacent each end. The apertures permit the cross piece 24 to slide onto the side rails 4 to make a more solid unit and yet adjustable unit. The upright members 8 also have apertures adjacent each end thereof for engagement with end rails 6 and first cross members 12. Upright support members 26 also have an aperture disposed adjacent a bottom end for sliding engagement with cross piece 24.

The connection means includes at least one of screws and bolts with nuts. Sheet metal screws (not shown) are used throughout to provide additional support. The nuts and bolts are seen in several of the Drawing Figures.

The at least two cross members 12 includes a first one of the at least two cross members 12 engageable adjacent an upper end of a second pair of the plurality of upright members 8 that are disposed on the front end of the substantially rectangular base member 2 and a second one of the two cross members 12 engageable adjacent an upper end of the first pair of plurality of upright members 8 disposed on the back end of the substantially rectangular base member 2.

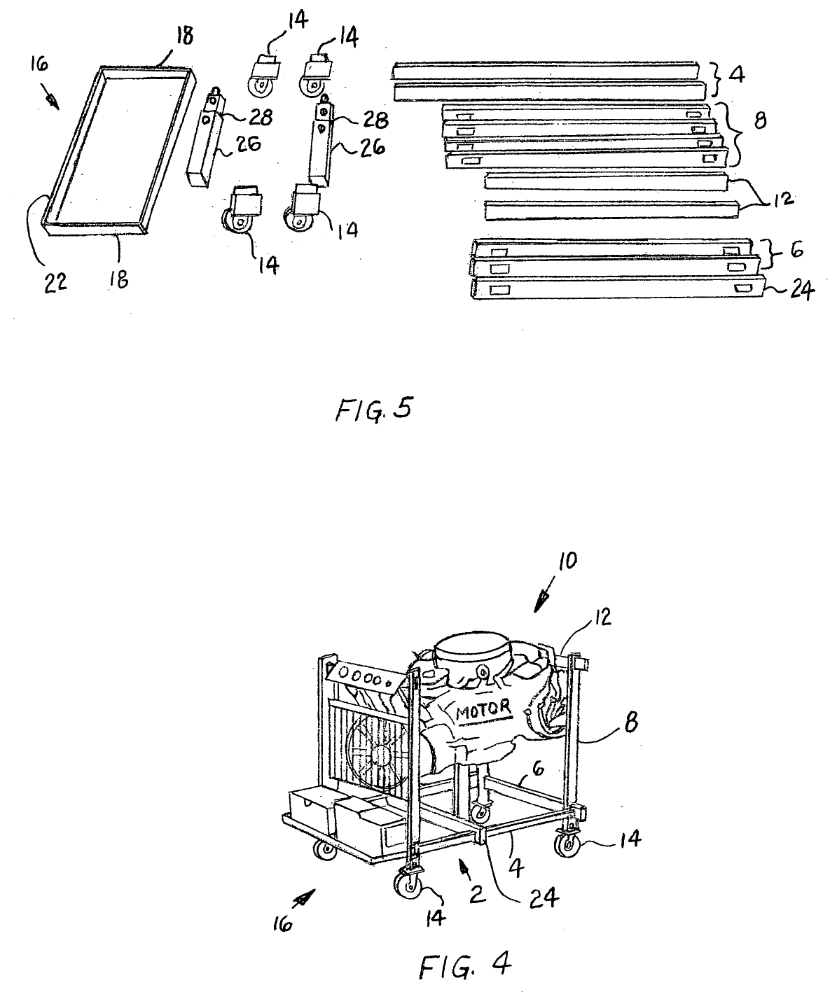

As is evident in FIGS. 1, 2 and 4, the apparatus 10 further includes a control panel 34. The control panel 34 is engageable with the second pair of the plurality of upright members 8 and is further engageable with the first one of the two cross members 12, such pair of upright members 8 being disposed on the front end of substantially rectangular base member 2. The control panel 34 is for controlling operation of such engine mounted on the apparatus 10.

The apparatus further includes a fan cover 38 for protecting a worker from blades of such fan.

Thus, the present invention provides an apparatus that is a vehicle engine prop that will keep an entire engine block upright and securely in place during building, rebuilding, servicing and teaching on the unit. The stand is made of durable yet lightweight materials and has a simple construction and deconstruction method simple enough that any consumer may perform the task of connecting the unit. The specially designed components fit together perfectly to offer support in the safest structural manner, for example, strategically located bolts, brackets and clips hold the engine in place at specific locations. The unit has wheels on the four corners which enable the mechanic or teacher to easily move the unit to any specific location for use. Bracket and shelf storage areas are designed to hold the radiator, fan battery and gasoline in place while the other components are being worked on. The unit measures approximately 48″ long by 40″ high by 36″ wide. The engine is simply dropped into the unit for work. Since the unit does not have any welds in it but is securely fastened by nuts and bolts and screws, the unit is adjustable so as to be able to handle different size engines.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for mounting an automotive engine thereon while such engine is one of being worked on and being used for teaching purposes, said apparatus comprising:
(a) a base member having each of a predetermined shape and a predetermined size, said base member including at least a pair of side rails and a pair of end rails wherein each of said pair of side rails is engageable with a respective end of each of said end rails so as to form a substantially rectangular base, said base member having each of a front end and a back end;
(b) a plurality of upright members engageable with said base member adjacent each corner of said substantially rectangular base member;
(c) at least two cross members, each one of said at least two cross members engageable with a pair of said plurality of upright members for providing support;
(d) a connection means for securing said side rails to said end rails and said plurality of upright members to said base member;
(e) a first engine support means engageable with said side rails of said base member;
(f) a second engine support means engageable with at least two of said plurality of upright members; and
(e) a plurality of wheels engageble with a bottom portion of each of said plurality of upright members disposed substantially at each said corner of said substantially rectangular base to provide mobility for said apparatus.

2. The apparatus, according to claim 1, wherein said base member further includes an additional portion extending beyond said front end of said substantially rectangular base member for providing an additional mounting area for a battery and for a fuel container.

3. The apparatus, according to claim 2, wherein said additional portion has two side members and two end members, each of said two side members engageable on a first end thereof with a respective end of one of said end members and on a second end thereof with a respective end of another of said end members, one of said end members being engageable with said end rail of said apparatus.

4. The apparatus, according to claim 1, wherein said first engine support means includes a cross piece engageable with said side rails of said base member, said cross piece disposed intermediate said front end and said back end of said substantially rectangular base member.

5. The apparatus, according to claim 4, wherein said first engine support means includes a pair of upright support members engageable with said cross piece at a first end thereof.

6. The apparatus, according to claim 5, wherein said pair of upright support members have a height adjustment means disposed therein for providing different heights for different engines to be mounted thereon.

7. The apparatus, according to claim 6, wherein said first engine support means includes a securement means for securing such engine to said second end of said first pair of engine support means.

8. The apparatus, according to claim 7, wherein said securement means includes bolts and nuts.

9. The apparatus, according to claim 1, wherein said second engine support means includes a pair of brackets engageable with a respective one of a first pair of said upright members for supporting a rear portion of such engine, said first pair of upright members disposed on said back end of said substantially rectangular base member.

10. The apparatus, according to claim 9, wherein said second engine support means is secured to said pair of upright members by means of nuts and bolts.

11. The apparatus, according to claim 1, wherein said connection means includes at least one of screws and bolts and nuts.

12. The apparatus, according to claim 1, wherein said at least two cross members includes a first one of said two cross members engageable adjacent an upper end of a second pair of said plurality of upright members disposed on said front end of said substantially rectangular base member and a second one of said two cross members engageable adjacent an upper end of said first pair of said plurality of upright members disposed on said back end of said substantially rectangular base member.

13. The apparatus, according to claim 12, wherein said apparatus further includes a control panel, said control panel engageable with said second pair of said plurality of upright members and further engageable with said first one of said two cross members, said second pair of upright members being disposed on said front end of said substantially rectangular base member, said control panel for controlling operation of such engine mounted on said apparatus.

14. The apparatus, according to claim 1, wherein said apparatus is adjustable.

15. The apparatus, according to claim 1, wherein said plurality of wheels are secured to said plurality of upright members by means of nuts and bolts.

16. The apparatus, according to claim 1, wherein said plurality of upright members have apertures disposed adjacent each end thereof for sliding engagement with said side rails and said at least two cross members.

17. The apparatus, according to claim 1, wherein said cross piece has apertures disposed adjacent each end thereof for sliding engagement with said side rails.
